(19) United States
(12) Patent Application Publication
(10) Pub. No.: US 2026/0094441 A1
(43) Pub. Date: Apr. 2, 2026

(54) Device and Method for Determining a Level of Encounter Between a Public-Safety Officer and a Person of Interest

(71) Applicant: MOTOROLA SOLUTIONS, INC., CHICAGO, IL (US)

(72) Inventors: CHUN SENG SONG, GEORGETOWN (MY); KEAN TONG CHOONG, GEORGETOWN (MY); CHUN WEN OOI, GEORGETOWN (MY)

(21) Appl. No.: 18/901,635

(22) Filed: Sep. 30, 2024

(51) Int. Cl. G06V 20/40; G06Q 50/26; G10L 25/63

(52) U.S. Cl. CPC G06V 20/46; G06Q 50/265; G10L 25/63

(57) ABSTRACT

A process of determining a level of encounter between a public-safety officer and a person of interest. An electronic computing device receives information related to a public-safety incident associated with a person of interest. The device detects an encounter between a public-safety officer and the person and captures, via an audio and/or video capture device, audio and/or video streams corresponding to the encounter between the officer and the person. The device analyzes the one or more audio and/or video streams using an audio and/or video analytics engine and determines a current level of the encounter between the officer and the person based on the analysis of the audio and/or video streams and the information related to the public-safety incident. The device provides an electronic output indicating the current level of the encounter between the public-safety officer and the person of interest.

### BACKGROUND

Dispatchers play a crucial role in coordinating and supporting police officers during encounters with suspects. Dispatchers often have limited information about the situation when they initially receive information about the encounter. Dispatchers most often rely on the officer's updates to understand the nature of the encounter with a suspect. However, police encounters with suspects can quickly evolve and become unpredictable. It is crucial for dispatchers to receive timely information during officer's encounters with suspects as dispatchers need to balance the urgency of different encounters and allocate resources effectively.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with some embodiments.

FIG. 2 is a block diagram of an electronic computing device in accordance with some embodiments.

FIG. 3 illustrates a flowchart of a process for determining a level of encounter between a public-safety officer and a person of interest in accordance with some embodiments.

FIG. 4 illustrates a table identifying a list of example factors that could be used for determining a level of encounter between a public-safety officer and a person of interest in accordance with some embodiments.

FIG. 5 illustrates an electronic dashboard displaying a status identifying a level of encounter determined between a public-safety officer and a person of interest in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

As described above, there is a need for dispatchers to receive timely information during officer's encounters with a person of interest such as a suspect associated with an incident. An officer's encounter with a person of interest may fall into one of many predefined levels. In one example, there are three main levels of police encounters. At a first level, a person may have a right to walk away or refuse to identify themselves, or inform the officer of their wish not to speak to them. At a second level, a person may not have the right to walk away or refuse to identify themselves, but the person could tell the officer that he or she does not wish to speak with the officer. At a third level, the officer may have the right to arrest or briefly detain a person of interest, but the person may remain silent with a right to an attorney. The above-mentioned levels of encounter may change depending on the laws and rules of the state as well as based on the policies of the public-safety agencies. Moreover, a level of encounter (also referred herein as “an encounter level” or “officer's encounter level”) may escalate or de-escalate during the officer's encounter with a person of interest. Regardless of the laws, rules, or policies used to define what is required for each level of encounter, there is a need to automatically analyze encounter situations and notify a dispatcher on a current level of encounter between the officer and the person of interest to enable the dispatcher to effectively allocate resources in response to the officer's encounter with the person of interest.

One embodiment provides a method of determining a level of encounter between a public-safety officer and a person of interest. The method comprises: receiving, at an electronic computing device, information related to a public-safety incident associated with a person of interest; detecting, at the electronic computing device, an encounter between a public-safety officer and the person of interest; capturing, at the electronic computing device, via an audio and/or video capture device, one or more audio and/or video streams corresponding to the encounter between the public-safety officer and the person of interest; analyzing, at the electronic computing device, the one or more audio and/or video streams using an audio and/or video analytics engine; determining, at the electronic computing device, a current level of the encounter between the public-safety officer and the person of interest based on the analysis of the one or more audio and/or video streams and the information related to the public-safety incident; and providing, at the electronic computing device, an electronic output indicating the current level of the encounter between the public-safety officer and the person of interest.

Another embodiment provides an electronic computing device, comprising: an electronic processor; and a visual and/or audio output device communicatively coupled to the electronic processor. The electronic processor is configured to: receive information related to a public-safety incident associated with a person of interest; detect an encounter between a public-safety officer and the person of interest; capture, via an audio and/or video capture device, one or more audio and/or video streams corresponding to the encounter between the public-safety officer and the person of interest; analyze the one or more audio and/or video streams using an audio and/or video analytics engine; determine a current level of the encounter between the public-safety officer and the person of interest based on the analysis of the one or more audio and/or video streams and the information related to the public-safety incident; and provide an electronic output indicating the current level of the encounter between the public-safety officer and the person of interest.

Each of the above-mentioned embodiments will be discussed in more detail below, starting with example system and device architectures of the system in which the embodiments may be practiced, followed by an illustration of processing blocks for achieving an improved technical process of determining a level of encounter between a public-safety officer and a person of interest. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

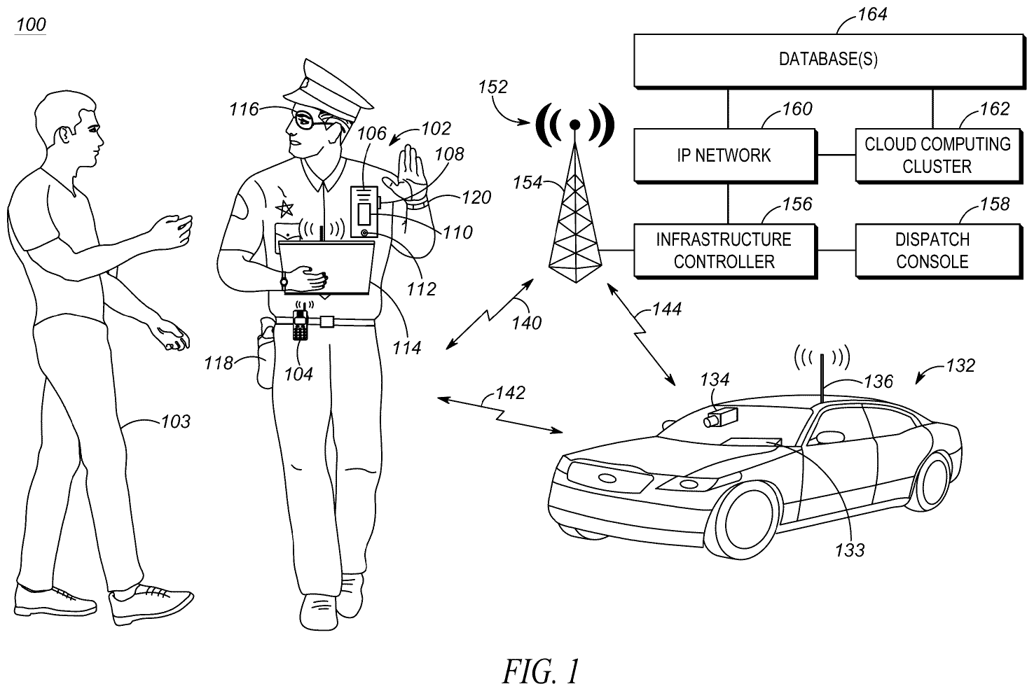

Referring now to the drawings, and in particular FIG. 1, a communication system 100 implementing a process for determining a level of encounter between a public-safety officer 102 and a person of interest 103 is shown. The officer 102 may be associated with any public-safety agency (e.g., police) which is responsible for responding to a public-safety incident and/or patrolling an area on foot or with a vehicle for checking for any activity that might pose a threat to safety of people. The communication system 100 includes a first set of computing devices that a public-safety officer 102 (illustrated in FIG. 1 as a police officer) may wear or operate, such as a primary battery-powered portable radio 104 used for narrowband and/or broadband direct-mode or infrastructure communications, a battery-powered radio speaker microphone (RSM) video capture device 106, a laptop 114 having an integrated video camera and used for data applications such as incident support applications, smart glasses 116 (for example, which may be virtual reality, augmented reality, or mixed reality glasses), sensor-enabled holster 118, and/or biometric sensor wristband 120. Although FIG. 1 illustrates only a single officer 102 with a respective first set of computing devices, in other embodiments, the officer 102 may include additional sets of same or similar devices, and additional users may be present with respective additional sets of same or similar devices.

System 100 may also include a vehicle 132 associated with the officer 102 having an integrated mobile communication device 133, an associated vehicular video camera 134, and a coupled vehicular transceiver 136. Although FIG. 1 illustrates only a single vehicle 132 with a single mobile communication device 133, respective single vehicular video camera 134 and/or microphone, and a single coupled vehicular transceiver 136, in other embodiments, the vehicle 132 may include additional same or similar mobile communication devices, video cameras, microphones, and/or transceivers, and additional vehicles may be present with respective additional sets of mobile communication devices, video cameras, microphones, and/or transceivers.

Each of the portable radio 104, RSM video capture device 106, laptop 114, and vehicular mobile communication device 133 may be capable of directly wirelessly communicating via direct-mode wireless link(s) 142, and/or may be capable of wirelessly communicating via a wireless infrastructure radio access network (RAN) 152 over respective wireless link(s) 140, 144 and via corresponding transceiver circuits. These computing devices are configured to receive inputs associated with the officer 102 and/or provide outputs to the officer 102 in addition to communicating information to and from other communication devices and the infrastructure RAN 152.

Many of the computing devices shown in FIG. 1 (such as the portable radio 104, the RSM video capture device 106, the laptop 114, the mobile communication device 133, the infrastructure controller 156, dispatch console 158, and one or more computing devices in the cloud computing cluster 162) may be referred to as communication devices. Although FIG. 1 shows multiple communication devices associated with the officer 102, in some embodiments, the communication system 100 includes communication devices of multiple officers. Further, the communication devices may form a talk group. In some embodiments, the communication devices communicate with each other over the infrastructure RAN 152 and/or communicate with each other directly as described herein. Similarly, other devices, such as the dispatch console 158, may communicate with communication devices of multiple users through the infrastructure RAN 152. In some embodiments, one or more officers may have multiple associated communication devices, for example, as shown in FIG. 1.

The portable radio 104, in particular, may be any communication device used for infrastructure RAN or direct-mode media (for example, voice, audio, video, etc.) communication via a long-range wireless transmitter and/or transceiver that has a transmitter transmit range on the order of miles, for example, 0.5-50 miles, or 3-20 miles (for example, in comparison to a short-range transmitter such as a Bluetooth, Zigbee, or NFC transmitter) with other communication devices and/or the infrastructure RAN 152. The long-range transmitter may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, the long range transmitter may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, the long range transmitter may implement a Wi-Fi protocol perhaps in accordance with an IEEE 802.11 standard (for example, 802.11a, 802.11b, 802.11g) or a WiMAX protocol perhaps operating in accordance with an IEEE 802.16 standard.

In the example of FIG. 1, the portable radio 104 may form the hub of communication connectivity for the officer 102, through which other accessory devices, such as a biometric sensor (for example, the biometric sensor wristband 120), an activity tracker, a weapon status sensor (for example, the sensor-enabled holster 118), a heads-up-display (for example, the smart glasses 116), the RSM video capture device 106, and/or the laptop 114 may communicatively couple.

In order to communicate with and exchange video, audio, and other media and communications with the RSM video capture device 106, laptop 114, and/or smart glasses 116, the portable radio 104 may contain one or more physical electronic ports (such as a universal serial bus (USB) port, an Ethernet port, an audio jack, etc.) for direct electronic coupling with the RSM video capture device 106, laptop 114, and/or smart glasses 116. In some embodiments, the portable radio 104 may contain a short-range transmitter (for example, in comparison to the long-range transmitter such as a LMR or Broadband transmitter) and/or transceiver for wirelessly coupling with the RSM video capture device 106, laptop 114, and/or smart glasses 116. The short-range transmitter may be a Bluetooth, Zigbee, or near field communication (NFC) transmitter having a transmit range on the order of 0.01-100 meters, or 0.1 -10 meters. In other embodiments, the RSM video capture device 106, the laptop 114, and/or the smart glasses 116 may contain their own long-range transceivers and may communicate with one another and/or with the infrastructure RAN 152 or vehicular transceiver 136 directly without passing through portable radio 104.

The RSM video capture device 106 provides voice functionality features similar to a traditional RSM, including one or more of acting as a remote microphone that is closer to the officer's 102 mouth, providing a remote speaker allowing playback of audio closer to the officer's 102 ear, and including a PTT switch/interface or other type of PTT input. The voice and/or audio recorded at the remote microphone may be provided to the portable radio 104 for storage and/or analysis or for further transmission to other mobile communication devices or the infrastructure RAN 152, or may be directly transmitted by the RSM video capture device 106 to other communication devices or to the infrastructure RAN 152. The voice and/or audio played back at the remote speaker may be received from the portable radio 104 or received directly from one or more other communication devices or the infrastructure RAN 152. The RSM video capture device 106 may include a separate physical PTT switch 108 that functions, in cooperation with the portable radio 104 or on its own, to maintain the portable radio 104 and/or RSM video capture device 106 in a monitor only mode, and which switches the device(s) to a transmit-only mode (for half-duplex devices) or transmit and receive mode (for full-duplex devices) upon depression or activation of the PTT switch 108. The portable radio 104 and/or RSM video capture device 106 may form part of a group communications architecture such as a talk group that allows a single communication device to communicate with one or more group members (not shown) associated with a particular group of devices at the same time.

Additional features may be provided at the RSM video capture device 106 as well. For example, a display screen 110 may be provided for displaying images, video, and/or text to the officer 102 or to someone else. The display screen 110 may be, for example, a liquid crystal display (LCD) screen or an organic light emitting display (OLED) display screen. In some embodiments, a touch sensitive input interface may be incorporated into the display screen 110 as well, allowing the officer 102 to interact with content provided on the display screen 110. A soft PTT input may also be provided, for example, via such a touch interface.

A video camera 112 may also be provided at the RSM video capture device 106, integrating an ability to capture images and/or video and store the captured image data (for further analysis) or transmit the captured image data as an image or video stream to the portable radio 104 and/or to other communication devices or to the infrastructure RAN 152 directly. The video camera 112 and RSM remote microphone may be used, for example, for capturing audio and/or video of a field-of-view associated with the officer 102, perhaps including a person of interest 103 (e.g., a civilian, a suspect, or a potential suspect) and the person's 103 surroundings, storing the captured image and/or audio data for further analysis or transmitting the captured audio and/or video data as an audio and/or video stream to the portable radio 104 and/or to other communication devices or to the infrastructure RAN 152 directly for further analysis. An RSM remote microphone of the RSM video capture device 106 may be an omni-directional or unidirectional microphone or array of omni-directional or unidirectional microphones that may be capable of identifying a direction from which a captured sound emanated.

In some embodiments, the RSM video capture device 106 may be replaced with a more limited body-worn camera that may include the video camera 112 and/or microphone noted above for capturing audio and/or video, but may forego one or more of the features noted above that transform the body worn camera into a more full featured RSM, such as the separate physical PTT switch 108 and the display screen 110, and remote microphone functionality for voice communications in cooperation with portable radio 104. In some embodiments, the system 100 may additionally or alternatively include a fixed surveillance camera or a mobile surveillance camera (e.g., drone camera) for monitoring the officer 102 and/or the officer's surroundings.

The laptop 114, in particular, may be any wireless communication device used for infrastructure RAN or direct-mode media communication via a long-range or short-range wireless transmitter with other communication devices and/or the infrastructure RAN 152. The laptop 114 includes a display screen for displaying a user interface to an operating system and one or more applications running on the operating system, such as a broadband PTT communications application, a web browser application, a vehicle history database application, a workflow application, a forms or reporting tool application, an arrest record database application, an outstanding warrant database application, a mapping and/or navigation application, a health information database application, and/or other types of applications that may require user interaction to operate. The laptop 114 display screen may be, for example, an LCD screen or an OLED display screen. In some embodiments, a touch sensitive input interface may be incorporated into the display screen as well, allowing the officer 102 to interact with content provided on the display screen. A soft PTT input may also be provided, for example, via such a touch interface.

Front and/or rear-facing video cameras may also be provided at the laptop 114, integrating an ability to capture video and/or audio of the officer 102 and the officer's 102 surroundings, perhaps including a field-of-view of the officer 102 and/or the person of interest 103 (e.g., a civilian, or a potential suspect) and the person's 103 surroundings, and store and/or otherwise process the captured video and/or audio for further analysis or transmit the captured video and/or audio as a video and/or audio stream to the portable radio 104, other communication devices, and/or the infrastructure RAN 152 for further analysis.

The smart glasses 116 may include a digital imaging device, an electronic processor, a short-range and/or long-range transceiver device, and/or a projecting device. The smart glasses 116 may maintain a bi-directional connection with the portable radio 104 and provide an always-on or on-demand video feed pointed in a direction of the officer's 102 gaze via the digital imaging device, and/or may provide a personal display via the projection device integrated into the smart glasses 116 for displaying information such as text, images, or video received from the portable radio 104 or directly from the infrastructure RAN 152. In some embodiments, the smart glasses 116 may include its own long-range transceiver and may communicate with other communication devices and/or with the infrastructure RAN 152 or vehicular transceiver 136 directly without passing through portable radio 104. In some embodiments, an additional user interface mechanism such as a touch interface or gesture detection mechanism may be provided at the smart glasses 116 that allows the officer 102 to interact with the display elements displayed on the smart glasses 116 or projected into the eyes of the officer 102, or to modify operation of the digital imaging device. In other embodiments, a display and input interface at the portable radio 104 may be provided for interacting with smart glasses 116 content and modifying operation of the digital imaging device, among other possibilities.

The smart glasses 116 may provide a virtual reality interface in which a computer-simulated reality electronically replicates an environment with which the officer 102 may interact. In some embodiments, the smart glasses 116 may provide an augmented reality interface in which a direct or indirect view of real-world environments in which the user is currently disposed are augmented (that is, supplemented, by additional computer-generated sensory input such as sound, video, images, graphics, GPS data, or other information). In still other embodiments, the smart glasses 116 may provide a mixed reality interface in which electronically generated objects are inserted in a direct or indirect view of real-world environments in a manner such that they may co-exist and interact in real time with the real-world environment and real world objects.

The sensor-enabled holster 118 may be an active (powered) or passive (non-powered) sensor that maintains and/or provides state information regarding a weapon or other item normally disposed within the officer's 102 sensor-enabled holster 118. The sensor-enabled holster 118 may detect a change in state (presence to absence) and/or an action (removal) relative to the weapon normally disposed within the sensor-enabled holster 118. The detected change in state and/or action may be reported to the portable radio 104 via its short-range transceiver. In some embodiments, the sensor-enabled holster 118 may also detect whether the officer's 102 hand is resting on the weapon even if it has not yet been removed from the holster and provide such information to portable radio 104. In some embodiments, a weapon of the officer 102 may include a sensor that detects when the weapon is discharged. The detected discharge may be reported to the portable radio 104, for example. Other possibilities exist as well.

The biometric sensor wristband 120 may be an electronic device for tracking an activity of the officer 102 or a health status of the officer 102, and may include one or more movement sensors (such as an accelerometer, magnetometer, and/or gyroscope) that may periodically or intermittently provide to the portable radio 104 indications of orientation, direction, steps, acceleration, and/or speed, and indications of health such as one or more of a captured heart rate, a captured breathing rate, and a captured body temperature of the officer 102, perhaps accompanying other information. In some embodiments, the biometric sensor wristband 120 may include its own long-range transceiver and may communicate with other communication devices and/or with the infrastructure RAN 152 or vehicular transceiver 136 directly without passing through portable radio 104.

An accelerometer is a device that measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

The heart rate sensor may use electrical contacts with the skin to monitor an electrocardiography (EKG) signal of its wearer (e.g., officer 102), or may use infrared light and imaging device to optically detect a pulse rate of its wearer, among other possibilities.

A breathing rate sensor may be integrated within the sensor wristband 120 itself, or disposed separately and communicate with the sensor wristband 120 via a short range wireless or wired connection. The breathing rate sensor may include use of differential capacitive circuits or capacitive transducers to measure chest displacement and thus breathing rates. In other embodiments, a breathing sensor can monitor a periodicity of mouth and/or nose-exhaled air (for example, using a humidity sensor, temperature sensor, capnometer or spirometer) to detect a respiration rate. Other possibilities exist as well.

A body temperature sensor may include an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities.

Although the biometric sensor wristband 120 is shown in FIG. 1 as a bracelet worn around the wrist, in other examples, the biometric sensor wristband 120 may additionally and/or alternatively be worn around another part of the body, or may take a different physical form including an earring, a finger ring, a necklace, a glove, a belt, or some other type of wearable, ingestible, or insertable form factor. In some embodiments, the biometric sensor wristband 120 or another device of the officer 102 may detect characteristics of the environment of the officer 102 (for example, temperature, humidity, air quality, wind direction, and the like).

The portable radio 104, RSM video capture device 106, laptop 114, smart glasses 116, sensor-enabled holster 118, and/or biometric sensor wristband 120 may form a personal area network (PAN) via corresponding short-range PAN transceivers, which may be based on a Bluetooth, Zigbee, Bluetooth Low Energy, WiFi, Near Field Communication (NFC), Radio Frequency ID (RFID) or other short-range wireless protocol having a transmission range on the order of meters, tens of meters, or hundreds of meters.

The portable radio 104 and/or RSM video capture device 106 (or any other device in FIG. 1, for that matter) may each include a location determination device integrated with or separately disposed in the portable radio 104 and/or RSM 106 and/or in respective receivers, transmitters, or transceivers of the portable radio 104 and RSM 106 for determining a location of the portable radio 104 and RSM 106. The location determination device may be, for example, a global positioning system (GPS) receiver or wireless triangulation logic using a wireless receiver or transceiver and a plurality of wireless signals received at the wireless receiver or transceiver from different locations, among other possibilities. The location determination device may also include an orientation sensor for determining an orientation that the device is facing. Each orientation sensor may include a gyroscope and/or a magnetometer. Other types of orientation sensors could be used as well. The location may then be stored locally or transmitted via the transmitter or transceiver to other communication devices and/or to the infrastructure RAN 152.

The vehicle 132 associated with the officer 102 may include the mobile communication device 133, the vehicular video camera 134 and/or microphone, and the vehicular transceiver 136, all of which may be coupled to one another via a wired and/or wireless vehicle area network (VAN), perhaps along with other sensors physically or communicatively coupled to the vehicle 132. The vehicular transceiver 136 may include a long-range transceiver for directly wirelessly communicating with communication devices such as the portable radio 104, the RSM 106, and the laptop 114 via wireless link(s) 142 and/or for wirelessly communicating with the RAN 152 via wireless link(s) 144. The vehicular transceiver 136 may further include a short-range wireless transceiver or wired transceiver for communicatively coupling between the mobile communication device 133 and/or the vehicular video camera 134 in the VAN. The mobile communication device 133 may, in some embodiments, include the vehicular transceiver 136 and/or the vehicular video camera 134 integrated therewith, and may operate to store and/or process video and/or audio produced by the video camera 134 and/or transmit the captured video and/or audio as a video and/or audio stream to the portable radio 104, other communication devices, and/or the infrastructure RAN 152 for further analysis. An omni-directional or unidirectional microphone (not shown), or an array thereof, may be integrated in the video camera 134 and/or at the mobile communication device 133 (or additionally or alternatively made available at a separate location of the vehicle 132) and communicatively coupled to the mobile communication device 133 and/or vehicular transceiver 136 for capturing audio and storing, processing, and/or transmitting the audio in a same or similar manner to the video as set forth above. The omni-directional or unidirectional microphone, or an array thereof, may be integrated in the video camera 134 and/or at the mobile communication device 133 (or additionally or alternatively made available at a separate location of the vehicle 132) and communicably coupled to the mobile communication device 133 and/or vehicular transceiver 136 for capturing audio and storing, processing, and/or transmitting the audio in a same or similar manner as set forth above with respect to the RSM 106.

The vehicle 132 may be a human-operable vehicle, or may be a self-driving vehicle operable under control of the mobile communication device 133 perhaps in cooperation with video camera 134 (which may include a visible-light camera, an infrared camera, a time-of-flight depth camera, and/or a light detection and ranging (LiDAR) device). Command information and/or status information such as location and speed may be exchanged with the self-driving vehicle via the VAN and/or the PAN (when the PAN is in range of the VAN or via the VAN's infrastructure RAN link). In some embodiments, devices within the vehicle 132 may communicate with devices in other vehicles via a Vehicular to Vehicular (V2V) Network.

The vehicle 132 and/or transceiver 136, similar to the portable radio 104 and/or respective receivers, transmitters, or transceivers thereof, may include a location (and/or orientation) determination device integrated with or separately disposed in the mobile communication device 133 and/or transceiver 136 for determining (and storing and/or transmitting) a location (and/or orientation) of the vehicle 132.

In some embodiments, instead of a vehicle 132, a land, air, or water-based drone with the same or similar audio and/or video and communications capabilities and the same or similar self-navigating capabilities as set forth above may be disposed, and may similarly communicate with the officer's 102 PAN and/or with the infrastructure RAN 152 to support the officer 102 in the field.

The VAN may communicatively couple with the PAN disclosed above when the VAN and the PAN come within wireless transmission range of one another, perhaps after an authentication takes place there between. In some embodiments, one of the VAN and the PAN may provide infrastructure communications to the other, depending on the situation and the types of devices in the VAN and/or PAN and may provide interoperability and communication links between devices (such as video cameras) and sensors within the VAN and PAN.

Although the RSM 106, the laptop 114, and the vehicle 132 are illustrated in FIG. 1 as providing example video cameras and/or microphones for use in capturing audio and/or video streams, other types of cameras and/or microphones could be used as well, including but not limited to, fixed or pivotable video cameras secured to lamp posts, automated teller machine (ATM) video cameras, other types of body worn cameras such as head-mounted cameras, other types of vehicular cameras such as roof-mounted cameras, drone cameras, or other types of audio and/or video recording devices accessible via a wired or wireless network interface same or similar to that disclosed herein.

In some embodiments, one or more of the officer 102, the vehicle 132, the portable radio 104, the RSM video capture device 106, and any other device in FIG. 1 may be equipped with an environmental sensor such as a chemical, biological, radiological, nuclear, or explosive (CBRNE) sensor. Measurements made by the CBRNE sensor may be stored locally or transmitted via a transmitter or transceiver to other communication devices and/or to the infrastructure RAN 152.

Infrastructure RAN 152 is a radio access network that provides for radio communication links to be arranged within the network between a plurality of communication devices. Such communication devices may be portable, mobile, or stationary and may include any one or more of the communication devices illustrated in FIG. 1, among other possibilities. At least one other terminal, for example used in conjunction with the communication devices, may be a fixed terminal, for example a base station, eNodeB, repeater, and/or access point. Such a RAN typically includes a system infrastructure that generally includes a network of various fixed terminals, which are in direct radio communication with the communication devices. Each of the fixed terminals operating in the RAN 152 may have one or more transceivers which may, for example, serve communication devices in a given region or area, known as a ‘cell’ or ‘site’, by radio frequency (RF) communication. The communication devices that are in direct communication with a particular fixed terminal are said to be served by the fixed terminal. In one example, all radio communications to and from each communication device within the RAN 152 are made via respective serving fixed terminals. Sites of neighboring fixed terminals may be offset from one another and may provide corresponding non-overlapping or partially or fully overlapping RF coverage areas.

Infrastructure RAN 152 may operate according to an industry standard wireless access technology such as, for example, an LTE, LTE-Advance, or 5G technology over which an OMA-PoC, a VoIP, an LTE Direct or LTE Device to Device, or a PoIP application may be implemented. Additionally or alternatively, infrastructure RAN 152 may implement a wireless local area network (WLAN) technology such as Wi-Fi perhaps operating in accordance with an IEEE 802.11 standard (for example, 802.11a, 802.11b, 802.11g) or such as a WiMAX perhaps operating in accordance with an IEEE 802.16 standard.

Infrastructure RAN 152 may additionally or alternatively operate according to an industry standard LMR wireless access technology such as, for example, the P25 standard defined by the APCO, the TETRA standard defined by the ETSI, the dPMR standard also defined by the ETSI, or the DMR standard also defined by the ETSI. Because these systems generally provide lower throughput than the broadband systems, they are sometimes designated narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) technique.

OMA-PoC, in particular and as one example of an infrastructure broadband wireless application, enables familiar PTT and “instant on” features of traditional half duplex communication devices, but uses communication devices operating over modern broadband telecommunications networks. Using PoC, wireless communication devices such as mobile telephones and notebook computers can function as PTT half-duplex communication devices for transmitting and receiving. Other types of PTT models and multimedia call models (MMCMs) are also available.

Floor control in an OMA-PoC session is generally maintained by a PTT server (also referred to as a talk group server) that controls communications between two or more wireless communication devices. When a user of one of the communication devices keys a PTT button, a request for permission to speak in the OMA-PoC session is transmitted from the user's communication device to the PTT server using, for example, a real-time transport protocol (RTP) message. If no other users are currently speaking in the PoC session, an acceptance message is transmitted back to the user's communication device and the user may then speak into a microphone of the communication device. Using standard compression/decompression (codec) techniques, the user's voice is digitized and transmitted using discrete auditory data packets (for example, together which form an auditory data stream over time), such as according to RTP and internet protocols (IP), to the PTT server. The PTT server then transmits the auditory data packets to other users of the PoC session (for example, to other communication devices in the group of communication devices or talkgroup to which the user is subscribed), using for example, one or more of a unicast, point to multipoint, or broadcast communication technique.

Infrastructure narrowband LMR wireless systems, on the other hand, operate in either a conventional or trunked configuration. In either configuration, a plurality of communication devices is partitioned into separate groups of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some embodiments, group IDs may be present in the group data to distinguish between groups using the same shared frequency).

In contrast, a trunked radio system and its communication devices use a pool of traffic channels for virtually an unlimited number of groups of communication devices (for example, talkgroups). Thus, all groups are served by all channels. The trunked radio system works to take advantage of the probability that not all groups need a traffic channel for communication at the same time. When a member of a group requests a call on a control or rest channel on which all of the communication devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the communication devices were idling to a traffic channel for the call, and instruct all communication devices that are not participating in the new call to move to a newly assigned control or rest channel selected from the pool of available channels. With a given number of channels, a much greater number of groups may be accommodated in a trunked radio system as compared with a conventional radio system.

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (for example, communication devices) could be provisioned in the network by the user or an agent, and then provided some form of group identity or identifier, for example. Then, at a future time, an originating user in a group may cause some signaling to be transmitted indicating that he or she wishes to establish a communication session (for example, group call) with each of the pre-designated participants in the defined group. In another example, communication devices may dynamically affiliate with a group (and also disassociate with the group) perhaps based on user input, and the switching and/or radio network may track group membership and route new group calls according to the current group membership.

In some instances, broadband and narrowband systems may be interfaced via a middleware system that translates between a narrowband PTT standard protocol (such as P25) and a broadband PTT standard protocol or application (such as OMA-PoC). Such intermediate middleware may include a middleware server for performing the translations and may be disposed in the cloud, disposed in a dedicated on-premises location for a client wishing to use both technologies, or disposed at a public carrier supporting one or both technologies. For example, and with respect to FIG. 1, such a middleware server may be disposed in infrastructure RAN 152 at infrastructure controller 156 or at a separate cloud computing cluster 162 communicably coupled to infrastructure controller 156 via internet protocol (IP) network 160, among other possibilities.

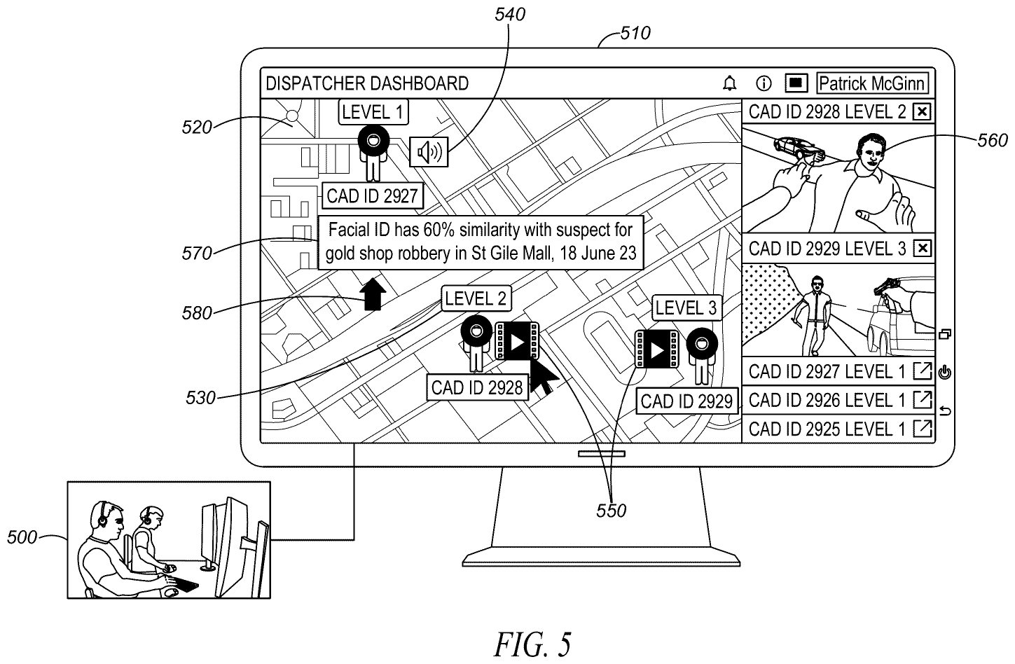

The infrastructure RAN 152 is illustrated in FIG. 1 as providing coverage for the portable radio 104, RSM video capture device 106, laptop 114, smart glasses 116, and/or vehicle transceiver 136 via a single fixed terminal 154 coupled to a single infrastructure controller 156 (for example, a radio controller, call controller, PTT server, zone controller, MME, BSC, MSC, site controller, Push-to-Talk controller, or other network device) and including the dispatch console 158 operated by a dispatcher (e. g, dispatcher 500 shown in FIG. 5). In other embodiments, additional fixed terminals and additional controllers may be disposed to support a larger geographic footprint and/or a larger number of mobile devices.

The infrastructure controller 156 illustrated in FIG. 1, or some other back-end infrastructure device or combination of back-end infrastructure devices existing on-premises or in the remote cloud computing cluster 162 accessible via the IP network 160 (such as the Internet), may additionally or alternatively operate as a back-end electronic digital assistant, a back-end audio and/or video processing device, and/or a remote cloud-based storage device consistent with the remainder of this disclosure.

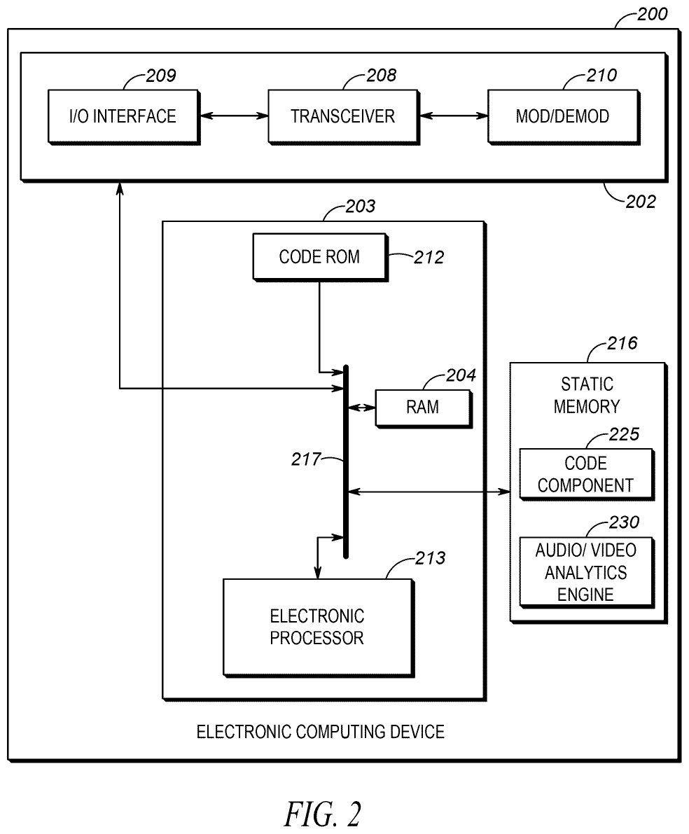

The IP network 160 may comprise one or more routers, switches, LANs, WLANs, WANs, access points, or other network infrastructure, including but not limited to, the public Internet. The cloud computing cluster 162 may be comprised of a plurality of computing devices, such as the one set forth in FIG. 2, one or more of which may be executing none, all, or a portion of an electronic digital assistant service, sequentially or in parallel, across the one or more computing devices. The one or more computing devices comprising the cloud computing cluster 162 may be geographically co-located or may be separated by inches, meters, or miles, and inter-connected via electronic and/or optical interconnects. Although not shown in FIG. 1, one or more proxy servers or load balancing servers may control which one or more computing devices perform any part or all of the electronic digital assistant service.

As shown in FIG. 1, database(s) 164 may be accessible via the IP network 160 and/or the cloud computing cluster 162. As shown in FIG. 1, the databases 164 are communicatively coupled with the infrastructure RAN 152 to allow the communication devices (for example, the portable radio 104, the RSM video capture device 106, the laptop 114, and the mobile communication device 133) to communicate with and retrieve data from the databases 164 via infrastructure controller 156 and IP network 160. In some embodiments, the databases 164 are commercial cloud-based storage devices. In some embodiments, the databases 164 are housed on suitable on-premises database servers. The database(s) may include databases such as a long-term video storage database, a historical or forecasted weather database, an offender database perhaps including facial recognition images to match against, a cartographic database of streets and elevations, a traffic database of historical or current traffic conditions, incident database including data such as incident assignment and timeline of incidents, or other types of databases. Databases 164 may further include all or a portion of the databases described herein as being provided at the infrastructure controller 156. In some embodiments, the databases 164 may be maintained by third parties (for example, the National Weather Service or a Department of Transportation, respectively). The databases 164 of FIG. 1 are merely examples. In some embodiments, the system 100 additionally or alternatively includes other databases that store different information. In some embodiments, the databases 164 and/or additional or other databases are integrated with, or internal to, the infrastructure controller 156.

Finally, although FIG. 1 describes a communication system 100 generally as a public safety communication system that includes a public-safety officer 102 generally described as a police officer and a vehicle 132 generally described as a police cruiser, in other embodiments, the communication system 100 may additionally or alternatively be a private security communication system including an officer 102 that may be an employee of a private security company and a vehicle 132 that may be a vehicle for use by the officer 102 in furtherance of the private security employee's duties (for example, a private security vehicle or motorcycle). Other possibilities exist as well.

FIG. 2 sets forth a schematic diagram that illustrates an electronic computing device 200 according to some embodiments of the present disclosure. The electronic computing device 200 may be, for example, embodied in the portable radio 104, the RSM video capture device 106, the laptop 114, the mobile communication device 133, the infrastructure controller 156, the dispatch console 158, one or more computing devices in the cloud computing cluster 162, or some other communication device not illustrated in FIG. 1, and/or may be a distributed communication device across two or more of the foregoing (or multiple of a same type of one of the foregoing) and linked via a wired and/or wireless communication link(s). In some embodiments, the electronic computing device 200 (for example, the portable radio 104) may be communicatively coupled to other devices such as the sensor-enabled holster 118 as described above. In such embodiments, the combination of the portable radio 104 and the sensor-enabled holster 118 may be considered a single electronic computing device 200. The electronic computing device 200 may include fewer or additional components (e.g., camera, microphone, speaker, display etc.,) in configurations different from that illustrated in FIG. 2.

As shown in FIG. 2, the electronic computing device 200 includes a communications unit 202 (also referred herein as a “communications interface”) coupled to a common data and address bus 217 of a processing unit 203. The electronic computing device 200 may also include one or more input devices (for example, keypad, pointing device, touch-sensitive surface, button, a microphone, an imaging device, and/or another input device) and an electronic display screen (which, in some embodiments, may be a touch screen and thus also acts as an input device), each coupled to be in communication with the processing unit 203. In accordance with some embodiments, the officer 102 may use the one or more input devices to confirm or reject a level of encounter determined by the electronic computing device 200 during the officer's encounter with the person 103. The microphone may be present for capturing audio from the officer 102 and/or other environmental or background audio (e.g., audio including speech detected from a person of interest 103) that is further processed by processing unit 203 in accordance with the remainder of this disclosure and/or is transmitted as voice or audio stream data, or as acoustical environment indications, by communications unit 202 to other portable radios and/or other communication devices. The imaging device may provide video (still or moving images) of an area in a field of view of the electronic computing device 200 for further processing by the processing unit 203 and/or for further transmission by the communications unit 202. A speaker may be present for reproducing audio that is decoded from voice or audio streams of calls received via the communications unit 202 from other portable radios, from digital audio stored at the communication device 200, from other ad-hoc or direct mode devices, and/or from an infrastructure RAN device, or may playback alert tones or other types of pre-recorded audio.

The processing unit 203 may include a code Read Only Memory (ROM) 212 coupled to the common data and address bus 217 for storing data for initializing system components. The processing unit 203 may further include an electronic processor 213 (for example, a microprocessor or another electronic device) coupled, by the common data and address bus 217, to a Random Access Memory (RAM) 204 and a static memory 216.

The communications unit 202 may include one or more wired and/or wireless input/output (I/O) interfaces 209 that are configurable to communicate with other communication devices, such as the portable radio 104, the laptop 114, the wireless RAN 152, the mobile communication device 133, and/or dispatch console 158. For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

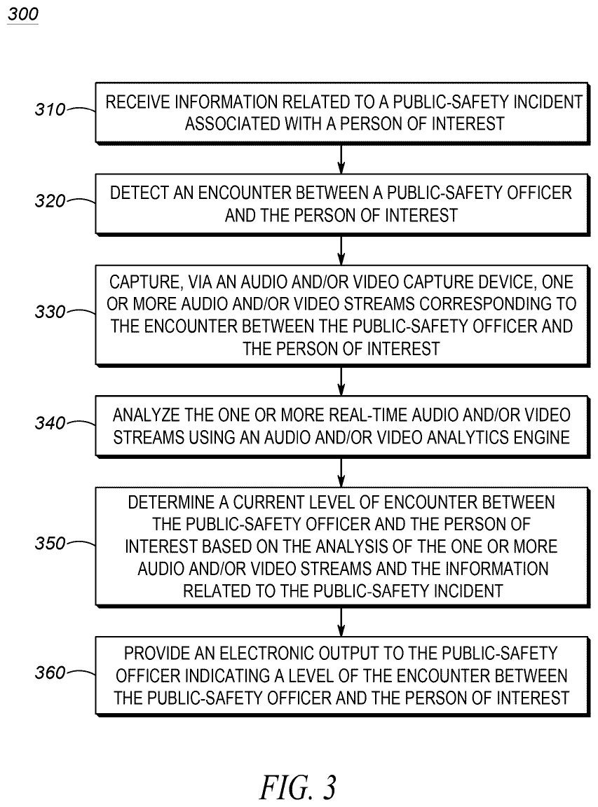

The electronic processor 213 has ports for coupling to other components (e.g., display, speaker, camera, microphone etc.,) included in the electronic computing device 200. Static memory 216 may store operating code 225 for the electronic processor 213 that, when executed, performs one or more of the steps set forth in FIG. 3 and the accompanying text. The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like.

In some embodiments, an individual component and/or a combination of individual components of the system 100 shown in FIG. 1 and/or components of the device shown in FIG. 2 may be referred to as an electronic computing device 200. The electronic computing device 200 may include a single electronic processor (for example, the electronic processor 213 of the portable radio 104). In other embodiments, the electronic computing device 200 includes multiple electronic processors distributed remotely from each other. For example, the electronic computing device 200 may be implemented on a combination of at least two of the electronic processor 213 of the portable radio 104, the electronic processor 213 of the infrastructure controller 156, and the electronic processor 213 of a back-end device in the cloud computing cluster 162 accessible via the IP network 160.

In accordance with embodiments, the electronic computing device 200 has access to an audio and/or video analytics engine 230. In one embodiment, the audio and/or video analytics engine 230 may be implemented within the electronic computing device 200 as shown in FIG. 2. For example, computer programs associated with the audio and/or video analytics engine 230 may be stored at the static memory 216. In another embodiment, the audio and/or video analytics engine 230 may be implemented at an edge computing device (e.g., microphone or camera(s) provided at one or more of the portable radio 104, RSM video capture device 106, body-worn camera, fixed or mobile surveillance camera, laptop 114, smart glass 116, or vehicle 132). Alternatively, the audio and/or video analytics engine 230 may be implemented on cloud computing devices and servers. In accordance with the embodiments, the electronic computing device 200 uses the metadata output by the audio and/or video analytics engine to determine a current level of encounter between a public-safety officer 102 and a person of interest 103. In accordance with embodiments, the electronic computing device 200 provides an electronic output to a computing device (e.g., portable radio 104) to the public-safety officer 102 indicating the determined level of encounter between the public-safety officer 102 and the person of interest 103. The electronic computing device 200 is further configured to present a status indicating the determined level of encounter to a computing device (e.g., a display screen coupled to a dispatch console 158) associated with a dispatcher.

FIG. 3 illustrates a flow chart diagram of a process 300 performed by the electronic computing device 200 for determining a level of encounter between a public-safety officer 102 and a person of interest 103. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure. The electronic computing device 200 may execute process 300 via an electronic processor, for example, processor 213 shown in FIG. 2.

The electronic computing device 200 may execute the process 300 at power-on, at some predetermined periodic time period thereafter, in response to a trigger raised locally at the electronic computing device 200 via an internal process or via an input interface (e.g., in response to a text or audio query received from the officer 102) or in response to a trigger (e.g., assignment of one or more incident-response tasks to the officer 102) from an external device (e.g., dispatch console 158 operated by a dispatcher) to which the electronic computing device 200 is communicably coupled, among other possibilities.

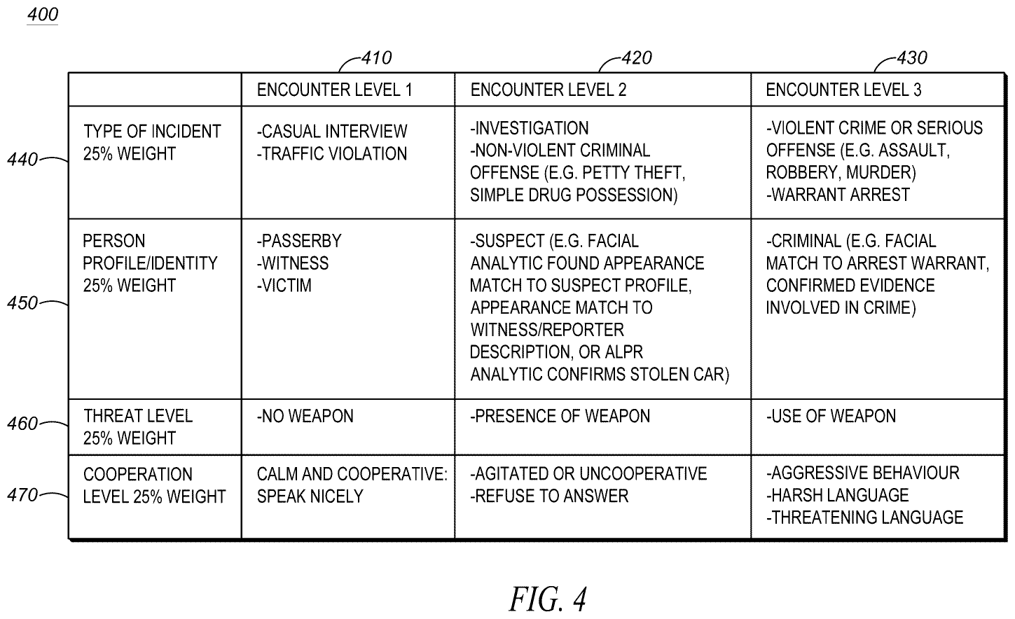

The process 300 of FIG. 3 need not be performed in the exact sequence as shown and likewise various blocks may be performed in different order or alternatively in parallel rather than in sequence. Some portions of the process 300 are described herein with reference to FIG. 4. The process 300 may be implemented on variations of the system 100 of FIG. 1 as well.

At block 310, the electronic computing device 200 receives information related to a public-safety incident associated with a person of interest 103. In one embodiment, the electronic computing device 200 receives information related to a public-safety incident in response to a dispatcher assigning one or more officers (e.g., public-safety officer 102) to respond to or to investigate the incident. As used herein, the term “dispatcher” refers to a system or individual responsible for monitoring and coordinating an encounter between an officer and a person of interest associated with an incident. The dispatcher may facilitate communication, track the status of the encounter, and provide relevant information about an incident in real-time to appropriate parties, including, but not limited to, law enforcement officers, support personnel, or automated systems. The dispatcher may also allocate resources (e.g., personnel, or equipment) based on the nature of the encounter (e.g., a levels of encounter determined in accordance with the process 300). In one embodiment, the dispatcher may assign an officer 102 to respond to or to investigate the incident in response to a caller reporting the incident to a public-safety answering point (e.g., via 911 call). In another embodiment, the electronic computing device 200 may receive information related to a public-safety incident in response to receiving an indication from the officer 102 indicating that the officer 102 is investigating the incident. The information related to the public-safety incident may include: an identifier (e.g., a computer aided dispatch (CAD) identifier) assigned to the incident, a location of the incident, a type and/or severity of the incident, identity (e. g,, name) and/or attributes of a person of interest (e.g., person 103), role of the person's involvement in the public-safety incident, and a name or identifier associated with an officer or agency responding to or investigating the incident. In another embodiment, the electronic computing device 200 obtains information related to a public-safety incident associated with a person of interest 103 when the electronic computing device 200 detects (as shown at block 320) an encounter between the public-safety officer 102 and the person of interest 103.

At block 320, the electronic computing device 200 detects an encounter between the public-safety officer 102 and the person of interest 103. As used herein, the term “person of interest” refers to any individual, including, but not limited to, a suspect, witness, or civilian, whose identity, conduct, or actions are relevant to an ongoing investigation or incident. The person of interest 103 may also include persons involved directly or indirectly in the occurrence of, or those who may possess information pertinent to the resolution or understanding of the incident. The person of interest 103 may also include individuals whose involvement is under investigation to clarify their role in relation to the incident. An encounter between an officer 102 and a person of interest 103, such as a suspect, may be detected when an officer 102 approaches, interacts, or otherwise confronts a person 103 during the course of an investigation of an incident or other law enforcement activity. This may include routine questioning, detainment, or more escalated situations such as a suspect pursuit. The encounter may also involve varying levels of engagement, from a brief exchange with a civilian to a more dynamic or tense confrontation with a suspect, depending on the nature of the encounter.

In one embodiment, the electronic computing device 200 detects an officer's encounter with the person of interest 103 based on an explicit input received from the officer 102. For example, in this embodiment, the officer 102 may receive an assignment from a dispatcher to locate and interview a person (e.g., person 103 shown in FIG. 1) reported to be involved in an incident (e.g., loitering near a grocery store). The officer 102 may use his or her device (e.g., portable radio 104) to indicate (e.g., via text or speech input) that the officer 102 has located the person of interest 103 described by the dispatcher and is ready to interview the person 103 in relation to the incident. The electronic computing device 200 monitors such text or speech input received from the officer 102 via the portable radio 104 and further determines that the text or speech input received from the officer 102 indicates that there is a potential encounter between the public-safety officer 102 and the person of interest 103. In one embodiment, in response to receiving an explicit input from the officer 102 indicating the officer's encounter with the person of interest 103, the electronic computing device 200 determines whether an audio and/or video capture device associated with the officer 102 has already been activated to record the officer's encounter with the person of interest 103. The audio and/or video capture device may include one or more of an audio capture device, a video capture device, or a device incorporating both audio and video capturing capabilities. As an example, the audio and/or video capture device may include one or more of microphones or cameras implemented at one or more of the portable radio 104, RSM video capture device 106, body-worn camera, fixed or mobile surveillance camera, laptop 114, smart glass 116, or vehicle 132 shown in FIG. 1. If the electronic computing device 200 determines that the audio and/or video capture device has not been activated to record the officer's encounter with the person of interest 103, then the electronic computing device 200 sends an electronic signal to an audio and/or video capture device (e.g., body-worn camera) to begin recording the encounter between the officer 102 and the person 103.

In another embodiment, the electronic computing device 200 automatically detects an encounter between the public-safety officer 102 and the person of interest 103 without explicit input from the officer 102. In this embodiment, the electronic computing device 200 is configured to continuously or periodically receive data captured by one or more of sensors (e.g., sensor-enabled holster 118, biometric sensor wristband 120, accelerometer, heart rate sensor, breathing rate sensor, body temperature sensor), audio capture devices (e.g.. microphone deployed at the RSM video capture device or body-worn camera), or video capture devices (e.g., body-worn camera). The electronic computing device 200 is configured to detect an encounter between the officer 102 and person 103 when data captured by one or more of the sensors, audio capture devices, or video capture devices indicate that the officer 102 is engaged in a questioning, confrontation, or in pursuit of a suspect. As an example, the electronic computing device 200 may use an audio analytics engine 230 employing natural language processing (NLP) capabilities to analyze speech (e.g., a predetermined phrase such as “stop” or “arrest”) captured (e.g., by a body-worn camera) corresponding to a conversation between the officer 102 and the person 103 to detect an encounter between the officer 102 and the person 103. As another example, the electronic computing device 200 may use a video analytics engine 230 to analyze a video captured corresponding to the officer 102 to detect a hand gesture (see FIG. 1) from the officer 102 indicating that the officer 102 is attempting to stop and interview a person of interest 103.

Regardless of how the encounter is detected between the officer 102 and the person of interest 103, at block 330, the electronic computing device 200 captures, via an audio and/or video capture device, one or more audio and/or video streams corresponding to the encounter between the officer 102 and the person 103. The audio and/or video capture device may include a microphone or camera implemented at one or more of one or more of the portable radio 104, RSM video capture device 106, body-worn camera, fixed or mobile surveillance camera, laptop 114, smart glass 116, vehicle 132, or any other computing device that is deployed in proximity to the location of the officer 102 and/or the person 103. In one embodiment, the electronic computing device 200 activates the audio and/or video capture device and captures one or more audio and/or video streams only in response to detecting an encounter between the officer 102 and the person 103. In embodiments where the audio and/or video capture device has been activated prior to detecting an encounter between the public-safety officer 102 and the person of interest 103, the electronic computing device 200 continues to capture audio and/or video streams corresponding to the encounter between the public-safety officer 102 and the person of interest 103. In these embodiments, the electronic computing device 200 may also adjust configuration (e.g., pan, tilt, or zoom settings of the camera) of the audio and/or video capture device in response to detecting an encounter between the officer 102 and the person 103.

At block 340, the electronic computing device 200 analyzes the audio and/or video capture streams captured corresponding to the encounter between the officer 102 and the person 103 using an audio and/or video analytics engine 230 shown in FIG. 2. The audio and/or video analytics engine 230 may include one or more of an audio analytics engine, a video analytics engine, or a combination of audio and video analytics engine. The audio analytics engine is configured to receive audio streams captured by audio capture devices, for example, a remote microphone provided at the RSM video capture device 106 and analyze the audio streams to determine properties or characteristics of captured audio streams and/or of persons (e.g., officer 102 or person 103), objects (e.g., weapon), or events represented in the audio streams. The video analytics engine is similarly configured to receive video streams captured by video capture devices, for example, cameras provided at one RSM video capture device 106 and analyze the video streams to determine properties or characteristics of the captured video streams and/or of persons, objects, or events found in the scene represented by the video streams. Based on the determinations made, the audio and/or video analytics engine 230 may further output metadata providing information about the determinations. Examples of determinations made by the audio and/or video analytics engine 230 may include person, object, or event detection, person, object, or event classification, anomaly detection, voice detection and recognition, facial detection and recognition, license plate recognition, identification of objects left behind or removed, business intelligence, and the like. The audio and/or video analytics engine 230 may be trained using any appropriate machine learning technique known in the art, including, but not limited to, convolution neural networks, inductive logic programming, support vector machines, random forests, cascade classifiers, decision trees, bayesian networks, sparse dictionaries, and genetic algorithms.

At block 350, the electronic computing device 200 determines a level of encounter between the public-safety officer 102 and the person of interest 103 based on the analysis of the one or more audio and/or video streams and the information related to the public-safety incident. In accordance with embodiments, an officer's level of encounter with a person of interest 103 may fall into one of a plurality of predefined levels. The levels of encounters may be predefined in any manner in accordance with the laws, rules and regulations, or policies governing a particular public-safety agency with which the officer 102 is associated. As an example, a public-safety agency may define three levels of encounter including a first level, a second level, and a third level. For instance, a first level of encounter may indicate a consensual encounter between the officer 102 and person 103, where the person 103 has the right to walk away from the officer 102. The second level of encounter may indicate an investigatory stop where the person 103 is not yet under arrest, but has no right to walk away from the officer 102. The third level of encounter indicates that the person of interest 103 is under arrest. In this example, the electronic computing device 200 may determine the officer's encounter with the person 103 at any given point in time as falling into only one particular level identified from the first, second, and third levels defined by the agency. The electronic computing device 200 may increase a currently determined level of encounter to a higher level of encounter (e.g., from a first level to a second level) as the encounter between the officer 102 and the person 103 escalates. The electronic computing device 200 may similarly decrease a currently determined level of encounter to a lower level of encounter (e.g., from a second level to a first level) as the encounter between the officer 102 and the person 103 de-escalates. The escalation or de-escalation of the encounter is determined by the electronic computing device 200 by continuously or periodically capturing new audio and/or video streams from the audio and/or video capture devices during the encounter between the officer 102 and the person 103.

The above definitions for three levels of encounters are provided as examples only and that there could be a lesser or higher number of levels. Moreover, different public-safety agencies may define different levels differently in accordance with the laws, rules and regulations, or policies governing the respective public-safety agencies. Such definitions provided by an agency can be translated into a rule engine for use by a computing device such as the electronic computing device 200 for determining a level of encounter between any public-safety officer associated with the agency and a person of interest 103. The rule engine may be provisioned at the electronic computing device 200 (e.g., at the static memory 216 shown in FIG. 2) or at a different device, and made accessible to the electronic computing device 200 to enable the electronic computing device 200 to determine whether an encounter detected between the officer 102 and the person 103 meets the definitions of one of multiple level of encounters predefined by the agency.

An example rule engine is illustrated in the form of a table 400 shown in FIG. 4. The table 400 includes a list of factors or analytics data to be captured and processed by the electronic computing device 200 for determining a current level of encounter between the officer 102 and the person 103. For example, an agency may define three possible levels of encounters including a first level 410, a second level 420, and a third level 430. The factors shown in table 400 include a type (or severity) of the incident 440, profile, identity, or role 450 of a person of interest, a level of threat 460 posed by the person of interest, and a level of cooperation demonstrated 470 by the person of interest. Additional factors may exist as well. The electronic computing device 200 may be configured to apply weights for each of the factors included in the table 400. In one example, the electronic computing device 200 may apply equal weights i.e., 25% each for the type or severity of the incident 440, profile, identity, or role 450 of the person, threat level 460, and cooperation level 470. The factors shown in FIG. 4 are merely examples and that these factors and a corresponding weight applied to each factor can be customized depending on the respective laws, rules and regulations, and policies used by the agencies for defining the different levels of encounter.

In accordance with some embodiments, the electronic computing device 200 extracts information corresponding to one or more of the listed factors either based on the analysis of the audio and/or video streams captured at block 330 or based on information received related to the public-safety incident at block 310. For example, the electronic computing device 200 may identify the type or severity of the incident and a role (e.g., as a witness, victim, or suspect) of the person's involvement in the public-safety incident using information received related to the public-safety incident. The electronic computing device 200 may also extract information corresponding to one or more of the factors such as identity or profile of the person of interest 103, a level of threat posed by the person of interest 103, and a level of cooperation demonstrated by the person of interest 103 by analyzing the audio and/or video streams using the audio and/or video analytics engine 230. In these embodiments, the electronic computing device 200 computes a level of the encounter between the public-safety officer 102 and the person of interest 103 as a function of one or more of the type or severity of the public-safety incident, the role of the person's involvement in the public-safety incident, identity of the person of interest 103, the level of threat posed by the person of interest 103, and the level of cooperation demonstrated by the person of interest 103.

In a first example, as illustrated in the table 400 shown FIG. 4, the electronic computing device 200 may determine a current level of encounter between the officer 102 and the person 103 as corresponding to a first level of encounter 410 when the incident is of a low severity or of a type where no criminal investigation is involved or the issues (e.g., minor traffic violation) involved are minor in nature. In such cases, the electronic computing device 200 may determine that the officer 102 would most likely be involved in routine information requests or inquiring about minor disturbances, without suspicion or criminal activity. The electronic computing device 200 may also further detect an identity, profile, or role of the person 103 being engaged by the officer 102 in relation to the incident. As an example, if the electronic computing device 200 identifies the person 103 as a passerby, witness, or victim either based on audio and/or video streams analyzed using the audio and/or video analytics engine 230 or based on information received from a dispatcher, then the electronic computing device 200 may determine that the officer's encounter with the person 103 will most likely fall under the first level of encounter.

The electronic computing device 200 is also configured to detect a level of threat posed by the person 103 and a level of cooperation demonstrated by the person 103 by processing the audio and/or video streams captured corresponding to the person 103. As an example, the threat level posed by the person 103 is low if the audio and/or video analytics engine 230 detects that the person is not in possession of any weapon. Similarly, the electronic computing device 200 may detect that the person's cooperation level is high if the audio and/or video analytics engine 230 detects that the person 103 is calm in speech and behavior during the encounter with the officer 102. In such situations when the threat level is low and the cooperation level is high, the electronic computing device 200 may determine that the officer's encounter with the person 103 will most likely fall under the first level of encounter. In accordance with some embodiments, the electronic computing device 200 weighs all the factors (i.e., type of incident 440, person profile, identity, or role 450, threat level 460, and cooperation level 470) in determining a current level of encounter between the officer 102 and the person 103. As an example, as shown in FIG. 4, the electronic computing device 200 applies equal weights (e.g., 25%) to each of the four factors included in the table 400 before determining that the current level of encounter between the officer 102 and the person of interest 103 falls under a first level of encounter as defined by an agency with which the officer 102 is associated.

In a second example, as illustrated in the table 400 shown in FIG. 4, the electronic computing device 200 may determine a current level of encounter between the officer 102 and the person 103 as corresponding to a second level of encounter 420 when the incident is of a medium severity or of a type involving a non-violent criminal investigation (e.g., petty theft). In such cases, the electronic computing device 200 may determine that the officer's encounter with the person of interest 103 will most likely fall under the second level of encounter which may allow the officer 102 to conduct an investigatory stop to briefly detain, question, or sometimes frisk the person of interest 103 for weapons. The electronic computing device 200 may also further detect an identity, profile, or role of the person 103 being engaged by the officer 102 in relation to the incident. The electronic computing device 200 may identify, by analyzing the audio and/or video streams captured corresponding to the person 103 using the audio and/or video analytics engine 230, that the person's facial features match with a suspect description stored corresponding to a currently investigated incident or to a previous incident. As an example, the officer 102 may be initially engaging with the person 103 based on an incident involving a petty theft. The electronic computing device 200 may capture an image of the person 103 during the officer's encounter with the person 103. By comparing facial features (or other unique attributes) of the person 103 with a warrant database, the electronic computing device 200 may determine that the person 103 has been named as a suspect in another incident involving a robbery. In this example, the electronic computing device 200 may also further identify, by analyzing the audio and/or video captured corresponding to a vehicle associated with the person 103 using the audio and/or video analytics engine 230, that the vehicle's license plate number matches with a license plate number of a reported stolen vehicle. In such cases, the electronic computing device 200 may determine that the officer's encounter with the person 103 will most likely fall under the second level of encounter. The electronic computing device 200 is also configured to detect a level of threat posed by the person 103 and a level of cooperation demonstrated by the person 103 by processing the audio and/or video streams captured corresponding to the person 103. As an example, the threat level posed by the person 103 may increase when the electronic computing device 200 detects that the person 103 is in possession of a weapon. Similarly, the electronic computing device 200 may detect that the person 103 is not cooperating if the audio and/or video analytics engine detects that the person 103 is agitated and/or refusing to answer the officer's questions. In such situations, the electronic computing device 200 may determine that the officer's encounter with a person 103 will most likely fall under the second level of encounter based on the presence of the weapon and the person's refusal to cooperate with the officer 102. In accordance with some embodiments, the electronic computing device 200 weighs all the factors (i.e., type of incident 440, person profile, identity, or role 450, threat level 460, and cooperation level 570) in determining a current level of encounter between the officer 102 and the person 103. As an example, as shown in FIG. 4, the electronic computing device 200 applies equal weights (e.g., 25%) to each of the four factors included in the table 400 before determining that the current level of encounter between the officer 102 and the person of interest 103 falls under a second level of encounter as defined by an agency with which the officer 102 is associated.

In a third example, as illustrated in the table 400 shown FIG. 4, the electronic computing device 200 may determine a current level of encounter between the officer 102 and the person 103 as corresponding to a third level of encounter 420 when the incident is of a high severity or of a type involving a violent criminal incident (e.g., assault, robbery etc.,). In such cases, the electronic computing device 200 may determine that the officer's encounter with the person of interest 103 will most likely fall under the third level of encounter which enables the officer to arrest the individual. The electronic computing device 200 may also further detect an identity, profile, or role of the person being engaged by the officer 102 in relation to the incident. For instance, the electronic computing device 200 may identify, by analyzing the audio and/or video captured corresponding to the person 103 using the audio and/or video analytics engine 230, that the person's facial features match with a suspect description stored corresponding to a currently investigated criminal incident or the suspect's profile matches with a pending arrest warrant. In such cases, the electronic computing device 200 may determine that the officer's encounter with the person 103 will most likely fall under the third level of encounter. The electronic computing device 200 is also configured to detect a level of threat posed by the person and a level of cooperation demonstrated by the person 103 by processing the audio and/or video streams captured corresponding to the person 103. As an example, the threat level posed by the person 103 may be high and imminent when the electronic computing device 200 detects that the person is in use of a weapon. Similarly, the electronic computing device 200 may detect that the person 103 is not cooperating if the audio and/or video analytics engine detects that the person 103 is aggressive in behavior and is using threatening language. In such situations, the electronic computing device 200 may determine that the officer's encounter with the person 103 will most likely fall under the third level of encounter based on the use of the weapon and the person's aggressive behavior and threatening language. In accordance with some embodiments, the electronic computing device 200 weighs all the factors (i.e., type of incident 440, person profile, identity, or role 450, threat level 460, and cooperation level 470) in determining a current level of encounter between the officer 102 and the person 103. As an example, as shown in FIG. 4, the electronic computing device 200 applies equal weights (e.g., 25%) to each of the four factors included in the table 400 before determining that the current level of encounter between the officer 102 and the person of interest 103 falls under a third level of encounter as defined by an agency with which the officer 102 is associated. In one embodiment, in the above example, the electronic computing device 200 may weigh each of the factors differently. As an example, the electronic computing device 200 may apply a higher weight (e.g., 40%) to threat level factor 460 in comparison to the weights (e.g., 20% each) applied to other factors such as the type of incident 440, person profile, identity, or role 450, or cooperation 470.

It is to be noted that the electronic computing device 200 continuously monitors the encounter between the public-safety officer 102 and the person of interest 103 and updates a current level of encounter when data captured corresponding to the one or more of the four factors included in the table 400 changes.

Returning to FIG. 3, at block 360, the electronic computing device 200 provides an electronic output indicating the current level of the encounter between the public-safety officer 102 and the person of interest 103. In accordance with embodiments, the electronic output is provided to the public-safety officer 102 as well as to the dispatcher. The electronic output may take the form of text, image, video, or audio. The electronic computing device 200 may provide the electronic output on a corresponding visual and/or audio output device. For example, the visual and/or audio output device may include a display component and/or a speaker component implemented on one or more computing devices (e.g., portable radio 104, laptop 114, mobile communication device 133, smart glass 166, dispatch console 158, etc.,) associated with the public-safety officer 102 or the dispatcher. The electronic output in the form of text, image, or video may be rendered via a display component of the visual and/or audio output device. The electronic output in the form of audio is played back via the speaker component of the one or more computing devices associated with the officer 102 or the dispatcher.

In accordance with embodiments, the electronic computing device 200 presents a status identifying the current level of encounter between the public-safety officer 102 and the person of interest 103 to a computing device associated with a dispatcher managing the public-safety incident. For example, referring to FIG. 5, a computing device used by a dispatcher 500 may include a display screen 510 rendering an electronic dashboard 520 that displays information corresponding to different incidents or encounters (e.g., CAD IDs 2925, 2926 etc., shown in FIG. 5) currently managed or handled by the dispatcher 500. The information related to the encounter includes, among other things, a status 530 indicating a current level of the encounter between the officer 102 and the person of interest 103, snippets of audio streams 540 or video streams 550 captured corresponding to the encounter, and an identifier (e.g., CAD ID 2928 shown in FIG. 5) of an incident that is being investigated by the officer 102 prior to or during the officer's encounter with the person 103. The electronic dashboard 520 may be continuously updated to show a status identifying information related to officer's encounters with persons of interest associated with different incidents. In accordance with embodiments, the status 530 identifying a current level of encounter may be updated to show an increased or decreased level of encounter either based on updated information received related to the public-safety incident to which the person of interest 103 is associated with or based on new audio 540 and/or video streams 550 captured corresponding to the encounter between the officer 102 and the person 103. As an example, at time ‘T1’, the electronic dashboard 520 may indicate that an officer 102 is at a first level of encounter (e.g., corresponding to CAD ID 2928 shown in FIG. 5) with a person of interest 103 (e.g., person 560 shown in FIG. 5), where, for example, the officer 102 is investigating a minor traffic violation. The electronic dashboard 520 may also include information identifying the identity of the officer 102, the incident being investigated by the officer 102, and the person's identity, profile, or role in relation to the incident. It is possible that the encounter may escalate from the first level of encounter to a second level of encounter at time ‘T2’ when information obtained corresponding to the person of interest 103 during a time period between ‘T1’ and ‘T2’ indicates that the person's facial features substantially match (e.g., 60% match) with facial features of a suspect named in another incident (e.g., robbery). In this case, the electronic dashboard 520 is automatically updated to show an updated status 530 identifying the second level of encounter as determined by the electronic computing device 200 based on additional information (e.g., information 570 indicating a 60% similarity between facial features of the person 560 and a suspect associated with a previous robbery incident as shown in FIG. 5) captured corresponding to the person of interest 103. In addition, the electronic dashboard 520 may also display a visual indicator in proximity to the status 530 identifying a current level of encounter to indicate whether the level has increased or decreased from a previously presented level of encounter. For example, as shown in FIG. 5, the visual indicator may include an arrow 580 pointing upwards to illustrate an increase in the encounter level corresponding to CAD ID 2928. Similarly, the visual indicator may be updated to show an arrow pointing downwards to illustrate a decrease in an encounter level.

Returning to FIG. 4, the electronic computing device 200 may further increase the current level of encounter to a third level of encounter at time ‘T3’ when the electronic computing device 200 detects the person 103 as behaving aggressively, using a weapon or speaking in a threatening language from the audio and/or video streams captured at time ‘T3’. In this case, the electronic dashboard 520 is automatically updated to show an updated status identifying the third level of encounter as determined by the electronic computing device 200 based on additional information captured corresponding to behavior of the person of interest 103. The electronic dashboard 520 presented to the dispatcher 500 may be similarly updated to show a decreased level of encounter as determined by the electronic computing device 200 based on updated information received corresponding to the public-safety incident or based on updated audio and/or video streams captured corresponding to the encounter between the officer 102 and the person 103. In accordance with embodiments, the electronic computing device 200 may further present one or more recommendations for the dispatcher 500 on the electronic dashboard 520 as a function of the current level of the officer's encounter with the person of interest 103. As an example, when the electronic computing device 200 determines that the officer's encounter with the person of interest 103 falls under a third or a highest level of encounter, the electronic computing device 200 may provide a prompt on the electronic dashboard 520 indicating the officer's encounter with the person of interest 103 has escalated to the third or highest level of encounter. The prompt may further request the dispatcher to dispatch additional resources (e.g., personnel or equipment) to respond to the officer's encounter with the person of interest 103.

In accordance with some embodiments, in response to determining the current level of the encounter between the officer 102 and the person of interest 103, the electronic computing device 200 further provides an electronic output, via a computing device (e.g., a portable radio 104) associated with the public-safety officer 102, to prompt the public-safety officer 102 to confirm the status identifying the current level of encounter as determined between the public-safety officer 102 and the person of interest 103. The prompt may be in the form of a text, image, video, audio, or haptic feedback. As an example, the prompt may include a text or audio input identifying the current level of encounter (e.g., “Level 1 Encounter”) determined by the electronic computing device 200 along with a request to the officer 102 to confirm or reject the current level of encounter determined by the electronic computing device 200. As another example, the prompt may be in the form of haptic feedback, where the electronic computing device 200 may control intensity or frequency of vibrations as a function of the level of encounter determined by the electronic computing device 200. The officer 102 may use one or more input devices (for example, keypad, pointing device, touch-sensitive surface, button, a microphone, an imaging device, and/or another input device) available to the officer 102 to confirm or reject the current level of encounter determined by the electronic computing device 200. As another example, when the prompt is provided as an audio output via a speaker, the officer 102 can provide speech input indicating that the officer 102 is either in agreement (e.g., with a speech input stating “yes”) or in disagreement (e. g,, with a speech input stating “no,” “maintain Level 1 encounter,” “revert to Level 1,” or “upgrade to Level 2”) with the current level of encounter determined by the electronic computing device 200. In accordance with some embodiments, the electronic computing device 200 may use the audio analytics engine employing NLP capabilities to recognize such speech input as corresponding to a confirmation (or rejection) of the encounter level determined by the electronic computing device 200 The prompt to the officer 102 may be provided concurrently with presenting the status identifying the officer's encounter level to the dispatcher. In some cases, the electronic computing device 200 may refrain from prompting the officer 102 to confirm the encounter level. As an example, the electronic computing device 200 may be programmed to refrain from prompting the officer 102 to confirm the encounter level when the encounter level corresponds to a situation (e.g., a third level of encounter where use of weapon is detected) where the officer 102 may be unable to confirm the encounter. As another example, the officer's electronic computing device 200 may be programmed to refrain from prompting the officer 102 based on predefined input received from the officer 102.

In embodiments where the electronic computing device 200 is programmed to prompt the officer 102 to confirm the level of encounter automatically determined by the electronic computing device 200, the electronic computing device 200 either maintains the status 530 of the encounter level presented to the dispatcher 500 or updates the status 530 of the encounter level presented to the dispatcher 500 based on input (or in some cases absence of input) received from the officer 102 in response to the prompt presented to the officer 102. When the officer 102 provides an input indicating officer's confirmation to the current level of encounter presented to the officer 102, or when no input is received from the officer 102 within a predefined period of time (e.g., 10 seconds, 1 minute, or 5 minutes) after prompting the officer 102, the electronic computing device 200 maintains or in other words makes no changes to the status 530 currently presented to the dispatcher 500 via the electronic dashboard 520.

When the officer 102 provides an input indicating that the officer 102 is not agreeing with the current level of encounter presented to the officer 102, the electronic computing device 200 determines a need to update the status 530 presented to the dispatcher 500. In this case, when the officer's input expressly specifies the new level of encounter, the electronic computing device 200 increases (e.g., from a first level of encounter determined by the electronic computing device 200 to a second or third level of encounter specified in the officer's input) or decreases (e.g., from a second level of encounter determined by the electronic computing device 200 to a first level of encounter specified in the officer's input) the current level of encounter to a new level of encounter in accordance with the officer's express input (e.g., speech input stating “maintain Level 1 encounter,” “revert to Level 1,” or “upgrade to Level 2”) .

Alternatively, when the officer's input (i.e., input rejecting the level of encounter determined by the electronic computing device 200) does not expressly specify a new level of encounter, the electronic computing device 200 captures, via the audio and/or video capture devices, one or more new audio and/or video streams corresponding to the encounter between the public-safety officer 102 and the person of interest 103. In addition, the electronic computing device 200 may also receive updated information related to the public-safety incident associated with the person of interest 103. The electronic computing device 200 then analyzes the new audio and/or video streams along with the updated information received related to the public-safety incident. Based on the analysis, the electronic computing device 200 may decide to increase or lower the current level of encounter to a new level of encounter between the officer 102 and the person of interest 103. As an example, assume that the electronic computing device 200 has determined the officer's current encounter with a person of interest 103 as falling under a first level of encounter based on one or more factors (extracted based on the analysis of audio and/or video streams captured corresponding to the encounter or based on incident information received from the dispatcher) that indicate that the incident is a minor traffic violation, the person of interest 103 is posing no threat to the officer 102, and the person is cooperating with the officer's investigation. Further assume that the officer 102 has provided an input (e.g., via a speech input “negative” detected from a microphone and recognized using an audio analytics engine) indicating that the officer 102 is disagreeing with the encounter level determined by the electronic computing device 200. In this case, the electronic computing device 200 may process additional audio and/or video streams captured corresponding to the encounter. In this case, it is possible that the electronic computing device 200 may extract new information indicating that the person of interest 103 is in possession of an object representing a weapon or that a license plate number of the vehicle occupied by the person 103 matches with a license plate number of a reported stolen vehicle. Alternatively, the electronic computing device 200 may also determine a new level of encounter based on a conversation between the officer 102 and the person 103. As an example, when the officer 102 informs the person 103 that the person 103 is under arrest, the electronic computing device uses the audio analytics engine to recognize keywords such as “you are under arrest” in the officer's conversation. The electronic computing device 200 then determines that the keywords “you are under arrest” corresponds to a third level of encounter defined by the agency. Accordingly, in these cases, based on additional information extracted by the electronic computing device 200, the electronic computing device 200 automatically, i.e., without the officer 102 expressly specifying the new level of encounter, determines to increase the level of encounter from a first level of encounter to a higher level of encounter.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of determining a level of encounter between a public-safety officer and a person of interest, comprising:
receiving, at an electronic computing device, information related to a public-safety incident associated with a person of interest;
detecting, at the electronic computing device, an encounter between a public-safety officer and the person of interest;
capturing, at the electronic computing device, via an audio and/or video capture device, one or more audio and/or video streams corresponding to the encounter between the public-safety officer and the person of interest;
analyzing, at the electronic computing device, the one or more audio and/or video streams using an audio and/or video analytics engine;
determining, at the electronic computing device, a current level of the encounter between the public-safety officer and the person of interest based on the analysis of the one or more audio and/or video streams and the information related to the public-safety incident; and
providing, at the electronic computing device, an electronic output indicating the current level of the encounter between the public-safety officer and the person of interest.

2. The method of claim 1, wherein determining comprises:
identifying, based on the analysis of the one or more audio and/or video streams and the information related to the public-safety incident, a type or severity of the public-safety incident, a role of the person's involvement in the public-safety incident; identity or profile of the person of interest, a level of threat posed by the person of interest, and a level of cooperation demonstrated by the person of interest; and
computing the current level of the encounter between the public-safety officer and the person of interest as a function of one or more of the type or severity of the public-safety incident, the role of the person's involvement in the public-safety incident, identity of the person of interest, the level of threat posed by the person of interest, and the level of cooperation demonstrated by the person of interest.

3. The method of claim 1, wherein the audio and/or video capture device is a body-worn camera associated with the public-safety officer, the method further comprising:
activating the body-worn camera to capture the one or more audio and/or video streams corresponding to the encounter between the public-safety officer and the person of interest in response to receiving a request from a dispatcher to locate and interview the person of interest or in response to receiving an input from the public-safety officer to activate the body-worn camera.

4. The method of claim 1, wherein providing the electronic output comprises:
presenting a status identifying the current level of encounter between the public-safety officer and the person of interest to a computing device associated with a dispatcher managing the public-safety incident.

5. The method of claim 4, wherein providing the electronic output comprises:
prompting, via a computing device associated with the public-safety officer, the public-safety officer to confirm the status identifying the current level of encounter between the public-safety officer and the person of interest.

6. The method of claim 5, further comprising:
maintaining the status presented to the computing device associated with the dispatcher when an input received via the computing device associated with the public-safety officer indicates officer's confirmation to the current level of encounter or when no input is received from the public-safety officer within a predefined period of time after prompting the public-safety officer.

7. The method of claim 5, further comprising:
determining a need to update the status presented to the computing device associated with the dispatcher when an input received via the computing device associated with the public-safety officer indicates that the public-safety officer is not agreeing with the current level of encounter as determined by the electronic computing device.

8. The method of claim 7, further comprising:
increasing or decreasing the current level of encounter to a new level of encounter between the public-safety officer and the person of interest when the input from the public-safety officer expressly specifies the new level of encounter; and
presenting an updated status identifying the new level of encounter between the public-safety officer and the person of interest to the computing device associated with the dispatcher.

9. The method of claim 7, further comprising:
capturing, using the audio and/or video capture device, one or more new audio and/or video streams corresponding to the encounter between the public-safety officer and the person of interest when the input from the public-safety officer does not expressly specify a new level of encounter;
receiving, at the electronic computing device, updated information related to the public-safety incident associated with the person of interest;
analyzing the one or more new audio and/or video streams corresponding to the encounter between the public-safety officer and the person of interest using the audio and/or video analytics engine;
increasing or lowering the current level of encounter to a new level of encounter between the public-safety officer and the person of interest based on the analysis of the one or more new audio and/or video streams and updated information related to the public-safety incident; and
presenting an updated status identifying the new level of encounter between the public-safety officer and the person of interest to the computing device associated with the dispatcher.

10. The method of claim 1, wherein the current level of encounter includes one of:
a first level of encounter indicating a consensual encounter where the person has the right to walk away from the public-safety officer;
a second level of encounter indicating an investigatory stop where the person is not under arrest, but has no right to walk away from the public-safety officer; or
a third level of encounter indicating an arrest where the person of interest is under arrest.

11. An electronic computing device, comprising:
a communications interface; and
an electronic processor communicatively coupled to the communications interface, the electronic processor configured to:
receive information related to a public-safety incident associated with a person of interest;
detect an encounter between a public-safety officer and the person of interest;
capture, via an audio and/or video capture device, one or more audio and/or video streams corresponding to the encounter between the public-safety officer and the person of interest;
analyze the one or more audio and/or video streams using an audio and/or video analytics engine;
determine a current level of the encounter between the public-safety officer and the person of interest based on the analysis of the one or more audio and/or video streams and the information related to the public-safety incident; and
provide an electronic output indicating the current level of the encounter between the public-safety officer and the person of interest.

12. The electronic computing device of claim 11, wherein the electronic processor is configured to:
identify, based on the analysis of the one or more audio and/or video streams and the information related to the public-safety incident, a type or severity of the public-safety incident, a role of the person's involvement in the public-safety incident; identity or profile of the person of interest, a level of threat posed by the person of interest, and a level of cooperation demonstrated by the person of interest; and
compute the current level of the encounter between the public-safety officer and the person of interest as a function of one or more of the type or severity of the public-safety incident, the role of the person's involvement in the public-safety incident, identity of the person of interest, the level of threat posed by the person of interest, and the level of cooperation demonstrated by the person of interest.

13. The electronic computing device of claim 11, wherein the electronic processor is configured to:
activate a body-worn camera operated by the public-safety officer to capture the one or more audio and/or video streams corresponding to the encounter between the public-safety officer and the person of interest in response to receiving a request from a dispatcher to locate and interview the person of interest or in response to receiving an input from the public-safety officer to activate the body-worn camera.

14. The electronic computing device of claim 11, wherein the electronic processor is configured to:
present a status identifying the current level of encounter between the public-safety officer and the person of interest to a computing device associated with a dispatcher managing the public-safety incident.

15. The electronic computing device of claim 14, wherein the electronic processor is configured to:
prompt, via a computing device associated with the public-safety officer, the public-safety officer to confirm the status identifying the current level of encounter between the public-safety officer and the person of interest.

16. The electronic computing device of claim 15, wherein the electronic processor is configured to:
maintain the status presented to the computing device associated with the dispatcher when an input received via the computing device associated with the public-safety officer indicates officer's confirmation to the current level of encounter or when no input is received from the public-safety officer within a predefined period of time after prompting the public-safety officer.

17. The electronic computing device of claim 15, wherein the electronic processor is configured to:
determine a need to update the status presented to the computing device associated with the dispatcher when an input received via the computing device associated with the public-safety officer indicates that the public-safety officer is not agreeing with the current level of encounter as determined by the electronic computing device.

18. The electronic computing device of claim 17, wherein the electronic processor is configured to:
increase or decrease the current level of encounter to a new level of encounter between the public-safety officer and the person of interest when the input from the public-safety officer expressly specifies the new level of encounter; and
present an updated status identifying the new level of encounter between the public-safety officer and the person of interest to the computing device associated with the dispatcher.

19. The electronic computing device of claim 17, wherein the electronic processor is configured to:
capture, using the audio and/or video capture device, one or more new audio and/or video streams corresponding to the encounter between the public-safety officer and the person of interest when the input from the public-safety officer does not expressly specify the new level of encounter;
receive updated information related to the public-safety incident associated with the person of interest;
analyze the one or more new audio and/or video streams corresponding to the encounter between the public-safety officer and the person of interest using the audio and/or video analytics engine;
increase or decrease the current level of encounter to a new level of encounter between the public-safety officer and the person of interest based on the analysis of the one or more new audio and/or video streams and updated information related to the public-safety incident; and
presenting an updated status identifying the new level of encounter between the public-safety officer and the person of interest to the computing device associated with the dispatcher.

20. The electronic computing device of claim 11, wherein the current level of encounter includes one of:
a first level of encounter indicating a consensual encounter where the person has the right to walk away from the public-safety officer;
a second level of encounter indicating an investigatory stop where the person is not under arrest, but has no right to walk away from the public-safety officer; or
a third level of encounter indicating an arrest where the person of interest is under arrest.
